(19) United States
(12) Patent Application Publication
(10) Pub. No.: US 2008/0159332 A1
(43) Pub. Date: Jul. 3, 2008

(54) Methods and devices for using variable length subpackets in data transmissions

(76) Inventor: John Christian Martinez, Dunstable, MA (US)

Correspondence Address: CAPITOL PATENT & TRADEMARK LAW FIRM, PLLC, P.O. BOX 1995, VIENNA, VA, 22183, US

(21) Appl. No.: 11/647,220

(22) Filed: Dec. 29, 2006

(51) Int. Cl. H04J 3/24

(52) U.S. Cl. 370/474; 370/392

(57) ABSTRACT

Egress scheduling using variable sized packets is completed without sacrificing quality by, among other things, segmenting entire packets into smaller variable sized subpackets, the length of each subpacket being indicated by an associated variable indicator field. Each subpacket is then assigned a slot in a sequence of slots, the sequence of slots forming a transmission frame. After being assigned to a slot, the framed subpackets may be transmitted in a fixed, sequential order.

### BACKGROUND OF THE INVENTION

Most carrier class routers operated by service providers (e.g., telephone companies) are capable of so-called egress scheduling of variable sized packets.

However, existing scheduling techniques are expensive and many times provide lower quality, real time services (e.g. voice) than traditional TDM transmission equipment.

Alternative queuing and traffic management algorithms have also been developed that allow for higher bandwidth utilizations rates, but at the expense of both increased complexity and cost.

The crux of the problem is that large packets have to be interleaved with lots of smaller packets. Many times, however, there is little or no room to complete such interleaving without a lot of shuffling and moving of packets. This movement of packets requires complex manipulations when delay and priority issues are factored in.

Yet another alternative is to use short and fixed ATM cell sizes. However, even this type of cell introduces too much delay into individual voice streams, especially when compressed voice traffic is used which is common in mobile phone systems.

Still further, AAL2 (spell out) attempts to address the problems encountered when compressed voice traffic needs to be transported, but its solutions are complex and require additional bandwidth.

### SUMMARY OF THE INVENTION

The inventors have recognized that the problems discussed above can be avoided by using conventional connection admission control methods (for real time services) coupled with novel transmission methods. More specifically, in accordance with the present invention the delays associated with providing real time services are reduced by transmitting variable sized fragments of larger packets. The delays are reduced to levels near that of tradition TDM transmissions even at 90%+bandwidth utilization.

The reduction in delays is achieved by segmenting entire packets into smaller variable sized subpackets, the length of each subpacket being indicated by an associated variable indicator field. Each subpacket is then assigned a slot in a sequence of slots, the sequence of slots forming a transmission frame. After being assigned to a slot, the framed subpackets may be transmitted in a fixed, sequential order.

More specifically, embodiments of the invention include methods and associated devices for: generating one or more segmented, variable size subpackets from portions of received, entire packets; and transmitting the subpackets in a fixed, sequential order. The methods and devices may further include: assigning a slot in a frame to each subpacket, wherein the frame contains one or more slots in sequential order; creating the frame by inserting each subpacket into its assigned slot; and inserting a variable indicator field for each assigned subpacket, wherein each indicator represents at least a length of a respective subpacket. Further, the length of the field may be changed to match the length of an assigned subpacket.

It is worthy of note that the methods and devices of the present invention add very little additional overhead to a transmission because variable sized headers are used and because the use of sequential slots allows subpackets and Parent Packets to be mapped in a straightforward manner.

### BRIEF DESCRIPTION OF THE DRAWINGS

FIG. 1 depicts the formation of a framed sequence of segmented subpackets according to embodiments of the present invention.

FIG. 2 depicts various values for a variable indicator field used in transmitting framed subpackets according to embodiments of the present invention.

### DETAILED DESCRIPTION OF THE INVENTION, WITH EXAMPLES

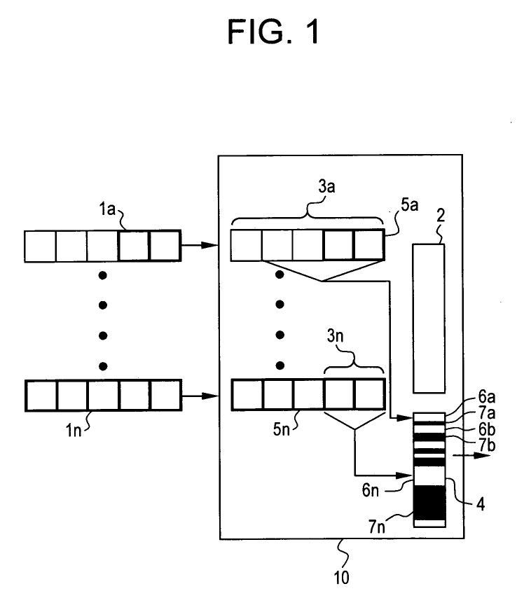

Referring to FIG. 1 there is shown so-called “Parent Packets” (PP) or whole packets 1a-1n (where “n’ represents the last PP) being received by one or more buffers 5a-5n. In accordance with an embodiment of the invention, a controller 2 or the like is operable to generate segmented, variable size subpackets from portions of the PPs 1a-1n received in the buffers 5a-5n, frame the subpackets and then control the transmission of the framed subpackets in a fixed, sequential order.

In more detail, at a given instant of time packets 3a making up a parent packet 1a are received and stored in buffer 5a, storage location, memory or the like. In accordance with the present invention, the controller 2 need not wait for the complete or whole parent packet 1a to be stored in the buffer 5a before transmitting some portion (e.g., packets 3a) of the parent packet 1a. Rather, the portion 3a of the parent packet 1a that has been stored in buffer 5a within a fixed time period may be transmitted. In accordance with the present invention, each of the portions 3a-3n representing a PP 1a-1n need not be the same size; thus the term “variable sized subpacket” may be used herein to describe such a portion of a PP. Though only a portion of the PP 1a may be transmitted, it should be understood that if the entire PP 1a has been stored before the time period has elapsed the entire PP 1a may be transmitted. Further, it should be understood that by “portion” of a PP is meant a whole number of bytes.

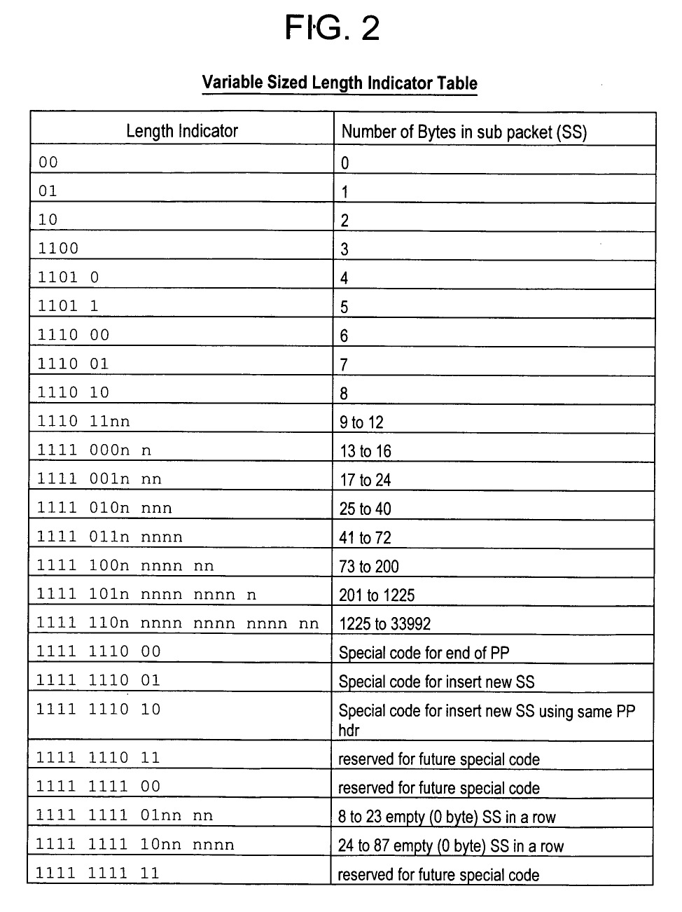

Continuing, each variable sized subpacket that is in a buffer is then assigned a Sequence Slot (SS or slot for short) 6a-6n in a frame 4 by the controller 2 or the like. During each transmission interval, the controller 2 or the like assigns subpackets to their respective slots and then creates a frame by inserting each subpacket into its so-assigned slot to form frame 4. In addition to the subpackets in slots 6a-6n, the controller 2 also inserts one or more indicators 7a-7n, one for each subpacket or slot 6a-6n, into the frame 4. In accordance with the invention each indicator 7a-7n at least indicates the length of a subpacket (i.e., PP portion) within a slot 6a-6n. Subsequently, the frame 4 and all of its subpackets and indicators 7a-7n are transmitted in accordance with a fixed, sequential order (e.g., slot 6a before 6b, followed by 6c, etc.,). It should be understood that each variable indicator 7a-7n forms a field whose length may be changed depending on the length of an associated, assigned packet. Thus, indicators 7a-7n may be referred to as variable indicator fields. FIG. 2 depicts various values for a variable indicator field according to embodiments of the present invention. Further, it should be understood that frame 4 may be stored in an output buffer or the like. For ease of understanding, however, the output buffer and frame are both identified as component 4 in FIG. 1. In all likelihood, though, the transmission of a frame would be started before the frame is completely formed or before the output buffer is full.

Sometimes an insufficient amount of data has been received by a buffer 5a-5n. Realizing this, the present invention provides for an alternative embodiment where a “zero byte” code is included in an indicator field 7a-7n to indicate such a condition.

As will be appreciated by those skilled in the art, because each slot is sent in a fixed, predictable manner and each subpacket is associated with a given PP, a receiver (not shown in FIG. 1) or the like that receives a transmitted frame can readily identify which PP a subpacket originally belonged to by keeping track of the sequence of transmitted/received slots. That is, separate addressing of subpackets is not required.

Each time a new PP is sent to a transmission buffer 5a-5n a new slot 6a-6n may assigned to a subpacket 3a-3n that may be derived from this PP. The assigned slot 6a-6n may be added to the end of a frame 4 that has not yet been transmitted. In accordance with the present invention, the sequential slot position 6a-6n that is assigned to the new subpacket may be at the end of a current frame 4 (e.g. if there are 4 slots 6a-6d being used when a new PP arrives at a buffer 5a-5n, then the new subpacket may be assigned slot 6e), or inserted somewhere in the middle of the frame 4. In the latter case, a special code or the like may be added to the indicator field 7a-7n that is eventually associated with the newly added subpacket/slot to indicate its position in the frame 4. This second insertion method allows a subpacket to be placed in a sequence/frame based on traffic parameters, for example, to reduce the effects of jitter and the like.

In accordance with yet additional embodiments of the invention, slots may be shifted when a certain PP is no longer being received by a buffer 5a-5n. For example, suppose slots 6a-6e within frame 4 are initially being utilized. Thereafter, the controller 2 or the like detects that the PP assigned to slot 6c is no longer being received by a buffer 5a-5n. Accordingly, the controller 2 may change the assignment of the remaining slots such that the PPs originally assigned to slots 6d and 6e are now assigned to different slots 6c and 6d, respectively. Along with reassigning slots, the controller 2 may reduce the number of slots in the frame (in this example, from 5 slots to 4) to make the transmission of the frame more efficient.

As with the length of each subpacket and its position, the end of each subpacket may also be indicated by placing a code or the like within the indicator field 7a-7n associated with each subpacket.

The use of segmented subpackets described above is believed to be a new way to perform egress scheduling. The controller 2, buffers 5a-5n and frame 8 may be a part of a device such as an IP router or MPLS switch. Further, it should be understood that the controller 2, buffers 5a-5n and other components shown in FIG. 1 may comprise the hardware, software and firmware necessary to carry out the features and functions of the invention described herein.

Because portions of all available PPs are transmitted at fixed, regular intervals, scheduling is simplified. Instead of juggling which packet to transmit and when to transmit them the present invention allows a router or the like to transmit subpackets by computing a transmission rate. Egress priority, egress fair bandwidth allocation, and egress shaping may all be implemented by controlling the maximum allowed transmission rate of a PP, that is, the maximum size of a subpacket. Further, because subpackets may be transmitted at fixed, regular intervals before an entire PP may be received, the effects of jitter and delay may be greatly reduced, especially during times of high bandwidth utilization.

The transmission methods described herein may be applied to direct, point-to-point communications, as well as to multi-node paths. In the former, slots may be reconstituted to form PPs at a receiver or the like at the two directly connected nodes. In the latter case, intermediary nodes along a path may change the slot assigned (and thus the position of) a given subpacket(s). However, if the egress transmission rate of subpackets is higher than the ingress transmission rate of PPs, then, in accordance with a further embodiment of the present invention, the entire PP will be assembled in a slot before it is transmitted. By doing so, the number of slots that must be used is kept to a minimum (i.e., a large number of slots may result in additional overhead due to frequent use of zero byte indicators, as well as the need for increased processing).

Though the inventions have been described with reference to the discussion above, it should be understood that this discussion only sets forth some of the ways and means in which the invention may be understood and practiced. Others are possible. Therefore, to appreciate the true scope of the present invention the following claims are presented.

We claim:

1. A method for transmitting variable sized subpackets comprising:
generating one or more segmented, variable size subpackets from portions of received, entire packets; and
transmitting the subpackets in a fixed, sequential order.

2. The method as in claim 1 further comprising:
assigning a slot in a frame to each subpacket, wherein the frame contains one or more slots in sequential order;
creating the frame by inserting each subpacket into its assigned slot; and
inserting a variable indicator field for each assigned subpacket into the frame, wherein a length of the field represents at least a length of a respective subpacket

3. The method as in claim 2 further comprising changing the length of the field to match the length of an assigned subpacket.

4. The method as in claim 2 wherein the indicator field includes a code to indicate an insufficient amount of data, associated with an entire packet, has been received.

5. The method as in claim 2 wherein the indicator field includes a code to indicate the end of a subpacket.

6. The method as in claim 1 further comprising:
assigning a slot in a frame to each subpacket, wherein the frame contains one or more slots in sequential order;
inserting one subpacket into an assigned slot in the middle of the frame, and
inserting a variable indicator filed into the frame, wherein the field includes an indication of the position of the subpacket in the frame to reduce the effects of jitter.

7. The method as in claim 2 further comprising:
changing the slot assignment of one or more subpackets when one or more entire packets are no longer received.

8. The method as in claim 2 further comprising:
reducing the number of slots in a frame to make the transmission of the frame more efficient.

9. A device for transmitting variable sized subpackets, the device operable to:
generate one or more segmented, variable size subpackets from portions of received, entire packets; and
transmit the subpackets in a fixed, sequential order.

10. The device as in claim 9 further operable to:
assign a slot in a frame to each subpacket, wherein the frame contains one or more slots in sequential order;
create the frame by inserting each subpacket into its assigned slot; and
insert a variable indicator field for each assigned subpacket, wherein the field represents at least a length of a respective subpacket

11. The device as in claim 10 further operable to change the length of the field to match the length of an assigned subpacket.

12. The device as in claim 10 wherein the indicator field includes a code to indicate an insufficient amount of data, associated with an entire packet, has been received.

13. The device as in claim 10 wherein the indicator field includes a code to indicate the end of a subpacket.

14. The device as in claim 9 further operable to:
assign a slot in a frame to each subpacket, wherein the frame contains one or more slots in sequential order;
insert one subpacket into an assigned slot in the middle of the frame, and
insert a variable indicator field into the frame, wherein the field includes an indication of the position of the subpacket in the frame to reduce the effects of jitter.

15. The device as in claim 10 further operable to:
change the slot assignment of one or more subpackets when one or more entire packets are no longer received.

16. The device as in claim 10 further operable to:
reduce the number of slots in a frame to make the transmission of the frame more efficient.
